(19) United States
(12) Patent Application Publication
(10) Pub. No.: US 2020/0075905 A1
(43) Pub. Date: Mar. 5, 2020

(54) BATTERY MODULE FOR A MOTOR VEHICLE AND MOTOR VEHICLE HAVING SUCH A BATTERY MODULE

(71) Applicant: AUDI AG, Ingolstadt (DE)

(72) Inventors: Michael HINTERBERGER, Grossmehring (DE); Markus THURMEIER, Adlkofen (DE)

(73) Assignee: AUDI AG, Ingolstadt (DE)

(21) Appl. No.: 16/521,130

(22) Filed: Jul. 24, 2019

(30) Foreign Application Priority Data
Aug. 28, 2018 (DE) 102018214545.8

(51) Int. Cl. H01M 2/02

(52) U.S. Cl. CPC H01M 2/0245; H01M 2220/20

(57) ABSTRACT

The disclosure relates to a battery module for a motor vehicle, including multiple prismatic battery cells, which are each enclosed by a housing. The respective housing has two housing walls arranged parallel to one another, which each provide a housing wall surface of the housing on the exterior. Multiple housings are arranged in succession in the battery module in such a way that in each case at least two exterior housing wall surfaces abut one another. In each housing, the housing wall surfaces each have a predetermined relief structuring, wherein the respective housing wall surfaces abutting one another have relief structurings formed corresponding to one another and are unconnected viewed perpendicularly in relation to the housing wall surface.

### FIELD

The disclosure relates to a battery module for a motor vehicle, comprising multiple prismatic battery cells, and a motor vehicle having such a battery module.

### BACKGROUND

Battery modules which comprise prismatic battery cells typically have a separate housing for each of the prismatic battery cells. This housing can be designed, for example, as an aluminum shell, which is welded to a housing cover, which has terminals for a positive and a negative pole of the battery cell. The aluminum shell can be produced, for example, by means of deep drawing and therefore has a planar surface. The individual housings having the respective battery cells accommodated therein can be arranged adjacent to one another in a battery module and are held together with the aid of metal compression plates, which are arranged at opposing ends of such battery cell packets, and tie rods or with the aid of metal tensioning straps.

A stackable holding part for a voltage-generating cell of an accumulator is described in EP 2 495 786 A1, which comprises a base wall and at least one frame wall protruding therefrom on one side of the base wall. The holding part has depressions and/or projections, which can interact with projections or depressions of an adjacent holding part and preferably form a catch, clip, and/or snap connection. In this way, on the one hand, a lateral displacement of the holding parts in relation to one another is precluded and moreover they can be permanently connected to one another.

A housing for a cell or a module of a battery is described in DE 10 2011 075 044 A1. This housing has at least one connecting element for forming a form-fitting plug connection with a connecting element of another battery component on at least one outer surface.

An energy storage device is described in DE 10 2011 015 152 A1. This energy storage device has a plurality of storage cells and a temperature control unit for the temperature control of the storage cells or a cell composite formed by the storage cells. A cell housing side wall can have a bent lower edge in a lower region in this case, wherein the other cell housing side wall has two bent tabs in an upper region. When assembled, the tabs of the other cell housing side wall engage adjacent to a material elevation on an upper narrow side of a cell housing frame, while the lower edge of the first cell housing side wall engages on a lower narrow side of the cell housing frame.

The individual described battery modules can each only compensate for a mechanical stress to a limited extent, however, which acts on the battery module, for example, in the event of a collision of the motor vehicle with an obstacle and because of which a deformation of the battery module can occur, since the respective housings of the described battery modules and the described battery cells of the respective battery module have a low rigidity.

It is the object of the invention to provide a battery module, the individual battery cells of which are more robust with respect to deformations of the individual battery cells because of deformation processes.

### SUMMARY

The object is achieved by a battery module according to the disclosure for a motor vehicle. Advantageous embodiments having expedient and nontrivial refinements of the disclosure are specified in the specification and the figures.

The battery module according to the invention for a motor vehicle comprises multiple prismatic battery cells, which are each enclosed using a housing. This respective housing of the battery cells, which is produced from aluminum, for example, has two housing walls arranged parallel to one another. By means of these two housing walls, housing wall surfaces are provided in each case on the exterior of the housing, i.e., the housing wall surfaces result on the exterior due to the housing walls. Multiple housings are arranged with one another in the battery module in such a way that in each case at least two exterior housing wall surfaces abut one another, namely in each case the two housing wall surfaces of housings touching one another. In this case, as is typical for housings of prismatic battery cells, each housing has a specific height and width, which are each greater in comparison to a depth of the housing. The at least two exterior housing wall surfaces, which abut one another inside the battery module, are preferably the housing wall surfaces defined by the height and width of the housing (wide sides) and not one of the housing wall surfaces arranged perpendicularly thereto (narrow sides), which is defined by the depth and the height or the depth and the width, respectively, of the housing. This results in the largest contact surface.

In every housing of the battery module, its housing wall surfaces arranged parallel to one another each have a predetermined relief structuring. A relief structuring in the meaning of the invention is understood to mean protruding structures and depressed structures in the housing wall surfaces. The predetermined relief structuring is not to be understood as an undercut in the present case, as can arise, for example, during foundry work, in the case of which an undercut can protrude freely on a cast part and can thus prevent this cast part from being able to be removed from its casting mold.

The respective housing wall surfaces abutting one another in pairs of two battery cells of the battery module have relief structurings formed corresponding to one another in this case and are unconnected perpendicularly in relation to the housing wall surface. The relief structuring of the housing wall surfaces abutting one another is thus designed in such a way that the two housing wall surfaces fit one into another because of the relief structuring thereof. The relief structurings on the housing wall surfaces are not designed in such a way that plugging or hooking of one housing wall into the other housing wall can occur, however. A fixed connection of the relief structurings of the housing wall surfaces abutting one another is thus not achieved, i.e., the two housing walls are not connected in a formfitting manner or adhesively bonded or fixedly coupled to one another in another manner, for example, in the region of the relief structurings. The relief structurings of the housing wall surfaces abutting one another are intermeshed with one another and engage in one another, but in the final analysis the two housing wall surfaces rest loosely on one another. In particular in the direction perpendicular to the housing wall surface, they can be separated from one another or moved apart without blockage, for example, if all surrounding obstructions, for example, a housing of the battery module itself, are removed. Depending on the formation of the relief structurings, however, a shear movement parallel to the plane of the housing wall surfaces can be suppressed or can only be possible with force expenditure due to the relief structurings, which are formed corresponding to one another or intermeshed with one another, of the housing wall surfaces abutting one another. The two housing wall surfaces abutting one another finally form two plastically structured partial surfaces matching with one another by means of the respective relief structurings thereof, which each form a counterpart to one another, i.e., a positive form and a negative form corresponding thereto.

Because of the relief structuring of the housing wall surfaces, the housing of each individual battery cell has a predetermined rigidity. The rigidity describes the resistance of a body against elastic deformation by a force or a torque. The rigidity of a component is generally dependent not only on the elastic properties of the material, but rather is also decisively dependent on the geometry of the component (bending rigidity). An enhanced rigidity of the housing walls according to the invention is thus achieved by means of the predetermined relief structuring. The housing walls therefore have an enhanced resistance to deformations, for example, as takes place due to an expansion of the individual battery cells in the course of time, the so-called swelling of battery cells. Moreover, housing walls having enhanced rigidity have a greater resistance in the event of accidents, during which the battery module can experience, for example, an external force action and deformations linked thereto. Deformations of housings of battery cells of the battery module because of internal and external forces can thus be reduced, since the housing walls according to the invention can compensate for greater forces at equal wall thickness because of the relief structuring than without the relief structuring.

The invention also includes embodiments, due to which additional advantages result. In a further advantageous embodiment of the invention, it is provided that in each housing, respectively one of the two exterior housing wall surfaces forms a front side of the housing and the other forms a rear side of the housing. The housing can thus have a precisely defined front and a precisely defined rear. The individual housings, which each comprise a prismatic battery cell, are typically arranged in succession inside the battery module, i.e., in each case the rear side of one housing abuts the front side of another housing arranged behind it. In the embodiment described here, both housing wall surfaces, i.e., the front side and the rear side of the housing, each comprise two halves of equal size. These two halves are delimited or partitioned by an axis of mirror symmetry of the housing wall surface, wherein this axis of mirror symmetry is arranged parallel to the housing wall surface and preferably perpendicularly to a housing side on which terminals for connecting a positive and negative electric pole of the battery cell are arranged.

The respective relief structuring of the two halves of the front side and the two halves of the rear side is formed in such a way that the front side is formed corresponding to the rear side and also in each case the two halves of the front side and accordingly also the two halves of the rear side are each formed corresponding to one another. For example, if a relief structuring which primarily has protruding or raised structures is located on the left half of the front side of the housing, for example, then the corresponding counterpart to this relief structuring is located on the right half of the front side, i.e., for example, a housing wall surface having predominantly countersunk structures. The rear side of the housing accordingly has on a right half upon direct observation, i.e., after turning around of the housing, the relief structuring corresponding to the left half of the front side, while in contrast the left half of the front side has the relief structuring corresponding to the right half of the front side. In this way, it is possible that two housing walls abutting one another fit into one another when the front side of one housing and the rear side of the other housing or in each case the same housing wall surface of the two housings abut one another. The individual housings of the battery module can thus be applied to one another precisely fitted in succession in the described manner, wherein housings can also be arranged rotated by 180° in relation to one another. Due to the fitting into one another of the housings arranged one behind another, the same installation space is finally required for the battery module as for a battery module, the individual battery cells of which are enclosed by housings, which each have smooth surfaces, as is the case, for example, with battery cell housings made of aluminum shells which were produced by means of deep drawing.

A further embodiment of the invention provides that in each housing, between the two housing walls, a housing cover perpendicular to these housing walls, having two terminals for one electrical pole of the battery cell in each case is arranged. The individual battery cells of the battery module typically have at least two electrodes, namely a positive and a negative electrode. They are connected by means of contact parts to a total of two current collectors, i.e., each individual battery cell has two terminals for in each case one electrical pole of the battery cell. The housing cover can be defined, for example, in its area by the depth and the width of the housing of the battery cell. Since the housing walls, the housing wall surfaces of which have the relief-type structure, are arranged perpendicularly to the housing cover, precisely the housing walls have the relief structuring which, because of swelling of the battery cell accommodated in the housing, experience the highest pressure and have to compensate for it. This is particularly advantageous with respect to the reduction of module tensions achieved by the housings inside the battery module as a result of the expansion of the individual battery cells during charging and discharging procedures and as a result of aging and wear processes of the battery cells caused by swelling.

A further advantageous embodiment of the invention provides that in each housing the housing cover is formed U-shaped. A U-shaped housing cover in the meaning of the invention means in this case both a rounded housing cover and also an angled housing cover, which thus has a middle part and two side parts arranged perpendicularly thereto. The side parts of the housing cover are arranged laterally in relation to the two housing walls and extend up to a housing base arranged parallel to the middle part of the housing cover. The U-shaped housing cover thus extends laterally in relation to the two housing walls up to the housing base. The housing cover formed in this manner, which separates the front side and the rear side of the housing from one another, can thus be manufactured from one material part, for example, from aluminum. The housing cover is thus producible particularly cost-effectively and in a technically simple manner.

In a further embodiment of the invention, it is provided that in each housing, the two housing walls, the housing cover, and the housing base are connected to one another in an integrally-joined manner. The two housing walls, which each provide on the exterior the housing wall surfaces of the housing, which each have the relief structuring, are thus fixedly connected to the U-shaped housing cover, which comprises the middle part and the two side parts, and also to the housing base. The integrally-joined connection can be formed, for example, as a welded bond or as a soldered bond. The battery cells can thus be accommodated particularly securely in the housing, shielded from surroundings of the housing. To optimize coupling to a cooling unit arranged below the battery module, for example, the housing base can be formed as a smooth surface. Moreover, the side parts of the housing cover can also be formed smooth, so that the battery module has smooth lateral surfaces to the outside. In this way, the battery module may be integrated in a particularly space-saving and advantageous manner into a motor vehicle. Alternatively thereto, the housing base and/or the side parts of the housing cover can also have a relief structuring, which is formed corresponding to the housing base and/or the side parts of the respective housing cover of housings arranged below it or adjacent to it. In this way, further particularly robust relative arrangements, because they have greater rigidity, of the individual housings inside the battery module are possible.

A further advantageous embodiment of the invention provides that in each housing, the two housings are each produced from one plate. This plate can be, for example, an aluminum plate. The two housing walls can moreover each be produced from a particularly thin plate in each housing, in particular from a plate having a wall thickness which is less than 1 mm. Materials can thus be used for producing the housing walls, which are already used for conventional housings for battery cells, for example, aluminum plates. Since the protruding structures of the relief structuring of the housing wall surfaces of the individual housings each fit into corresponding countersunk structures of the housing wall surfaces abutting thereon, i.e., correspond thereto and are accommodated thereby, there is thus no enlargement of the overall battery module in comparison to battery modules consisting of individual housings having smooth housing walls, since the same materials can be used. No additional installation space inside the motor vehicle is thus required by a battery module designed in this manner in comparison to a conventional battery module.

A further embodiment of the invention provides that each housing is sealed fluid-tight by means of a seal material. The individual housings are thus gas-tight and liquid-tight. For example, a foam strip, a seal ring, or a sealing wire can be used as the seal material. However, additionally or alternatively the material of the individual components of the housing itself can be used as the seal material, which was melted, for example, during the production of the integrally-joined connection between the two housing walls, the U-shaped housing cover, and the housing base and has solidified in such a way that a fluid-tight housing was formed. The housings, in which the individual battery cells of the battery module are arranged, are thus designed in such a way that no escape of liquids or gases out of the battery cell into the surroundings occurs, for example, no escape of an electrolyte of the battery cells. Moreover, the battery cells themselves are protected from liquids and gases from the surroundings of the battery module, for example, because of a penetration of rainwater into the surroundings of the battery module.

In a further embodiment of the invention, it is provided that housings arranged in succession are held together on a clamping device with respect to a direction perpendicular to the housing wall surfaces. The housings arranged in succession, which are arranged loosely in succession, since the housing wall surfaces are not fixedly connected to one another, are thus fixed by means of the clamping device in such a way that the individual housings cannot be moved away from one another at least perpendicularly to the housing wall surfaces without greater application of force. The clamping device can be, for example, metal tensioning straps which are tensioned around the battery module. Alternatively or additionally thereto, compression plates can be arranged on the two opposing ends of the battery module, i.e., on a first and last housing of the battery module, which compression plates are manufactured from metal, for example, and press together the housings of the battery module by means of tie rods. The outer shape of the battery module is thus fixedly predetermined by means of the clamping device depending on the dimensions of the housings. Moreover, due to the clamping device, displacement of the individual housings in relation to one another is also not possible parallel to the housing wall surfaces, since they are fixedly pressed against one another and are held together as a battery module. Although the individual housings are not fixedly connected to one another, a fixed composite of the individual housings inside the battery module can nonetheless be achieved with the aid of the clamping device.

A battery module for driving an electric drive machine of the motor vehicle is additionally provided according to the invention, wherein the battery module of the motor vehicle is designed as described above. The preferred embodiments and the advantages thereof presented in conjunction with the battery module according to the invention apply accordingly, if applicable, to the motor vehicle according to the invention.

### BRIEF DESCRIPTION OF THE DRAWINGS

The invention also comprises the combinations of the features of the described embodiments.

An exemplary embodiment of the invention is described hereafter. In the figures:

FIG. 1 shows a schematic illustration of a housing for a battery cell of a battery module, which has a housing wall surface having a relief structuring;

FIG. 2 shows a schematic internal view of a housing, which comprises a battery cell; and

FIG. 3 shows a schematic illustration of a battery module which comprises multiple prismatic battery cells, which are each enclosed by a housing, which has housing wall surfaces having a relief structuring.

### DETAILED DESCRIPTION

The exemplary embodiment explained hereafter is a preferred embodiment of the invention. In the exemplary embodiment, the described components of the embodiment each represent individual features of the invention to be considered independently of one another, which each also refine the invention independently of one another. Therefore, the disclosure is also to comprise combinations of the features of the embodiment other than those shown. Furthermore, the described embodiment can also be supplemented by further ones of the above-described features of the invention.

In the figures, identical reference signs each identify functionally-identical elements.

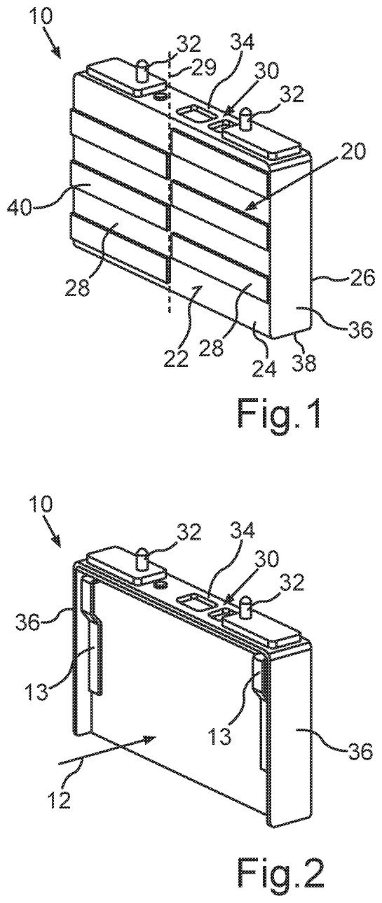

A housing 10 is outlined in FIG. 1, which has two housing walls 20 arranged parallel to one another. These two housing walls 20 arranged parallel to one another each provide a housing wall surface 22 of the housing 10 on the exterior. The two housing wall surfaces 22 can be differentiated in this case as a front side 24 of the housing 10 and as a rear side 26 of the housing 10. It is moreover outlined in FIG. 1 for the front side 24 that the front side 24 comprises two equal-sized halves 28. They are separated from one another by an axis of mirror symmetry, which is shown as a dashed line 29.

The housing 10 moreover comprises a housing cover 30, which is designed U-shaped and comprises a middle part 34 and two side parts 36. A U-shaped design in this case means either a housing cover 30 having rounded corners or an angled housing cover 30. This U-shaped housing cover 30 extends laterally in relation to the two housing walls 20 up to a housing base 38 arranged parallel to the middle part 34 of the housing cover 30. The housing cover 30 moreover has two terminals 32, each for one electrical pole of a prismatic battery cell 12 enclosed by the housing 10 (see reference sign 12 in FIG. 2).

The housing cover 30 having the middle part 34 and the side parts 36 and also the two housing walls 20 and the housing base 38 are integrally joined to one another and are produced, for example, from aluminum. The housing walls 20 themselves are produced in this case from an aluminum plate, which preferably has a wall thickness less than 1 mm. Moreover, the housing 10 is fluid-tight, i.e., it encloses a gas-tight and liquid-tight chamber, in which the battery cell 12 is arranged.

The two housing wall surfaces 22 each have a predetermined relief structuring 40, wherein the respective relief structuring 40 of the two halves 28 of the front side 24 and the two halves 28 of the rear side 26 is formed in such a way that both the front side 24 is formed corresponding to the rear side 26 and also the two halves 28 of one housing wall surface 22 are formed corresponding to one another.

An internal view of the housing 10 outlined in FIG. 1 is outlined in FIG. 2. The actual battery cell 12, i.e., its cell coil, is arranged in the interior of the housing 10. Moreover, the interior of the housing 10 has contact parts 13, which at least connect positive and negative electrodes of the battery cell 12 to the two terminals 32 of the housing cover 30. In FIG. 2, the U-shaped design of the housing cover 30 having the middle part 34 and the two side parts 36 is moreover particularly clear.

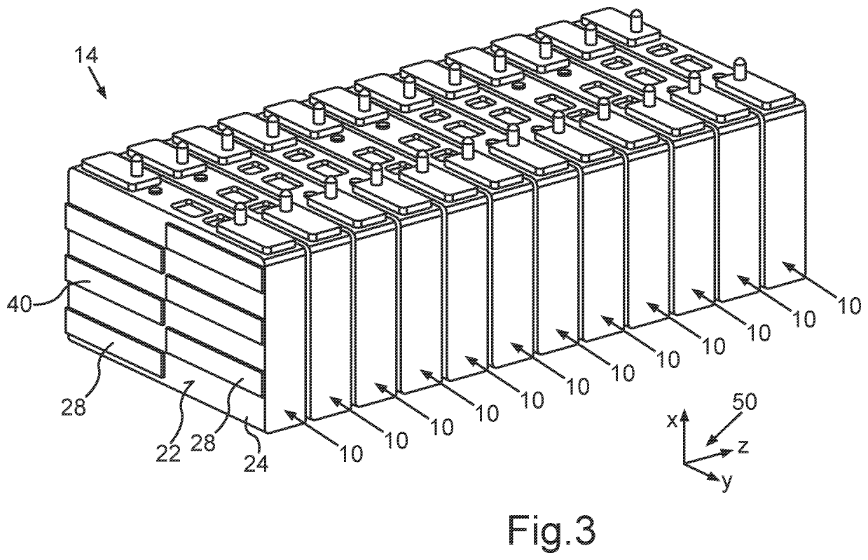

A battery module 14 which comprises multiple housings 10 is outlined in FIG. 3. The individual housings 10 each again comprise one individual prismatic battery cell 12 here, as outlined in FIG. 2. Multiple housings 10 are arranged in succession in the battery module 14 in such a manner that in each case at least one of the exterior housing wall surfaces 22 of the one housing 10 abuts one of the exterior housing wall surfaces 22 of another housing 10. For this purpose, the respective housing wall surfaces 22 abutting one another have relief structurings 40 formed corresponding to one another and are unconnected perpendicularly to the housing wall surface 22. The individual housings 10 are thus loosely arranged on one another, but fit into one another, since structures protruding out of one housing wall surface 22 are formed fitting into the structures countersunk in the housing wall surface 22 abutting thereon and vice versa. Since moreover the respective relief structuring 40 of the two halves 28 of the front side 24 and the two halves 28 of the rear side 26 is formed in such a manner that both the front side 24 is formed corresponding to the rear side 26 and also the two halves 28 of a housing wall surface 22 are formed corresponding to one another, two relief structurings 40 abutting one another of the housing walls 20 of the respective housings 10 can correspond to one another, if the front side 24 of the one housing 10 and the rear side 26 of the other housing 10 or in each case the same housing wall surface 22 of the two housings 10 abut one another.

The successively arranged housings 10 of the battery module 14 can moreover be held together with respect to a direction perpendicular to the housing wall surfaces 22 by a clamping device. This direction is shown with the aid of the coordinate system 50, wherein the direction perpendicular to the housing wall surfaces 22 is the Z direction.

The battery module 14 outlined in FIG. 3 is suitable, for example, as a battery module 14 for a motor vehicle, specifically for driving an electric drive machine of the motor vehicle.

Overall, the example shows how multiple housings 10 can be arranged in succession in a particularly space-saving manner inside a battery module 14 by means of the relief structuring 40 of the housing wall surfaces 22 of the housing 10, which comprises a battery cell 12. An enhanced rigidity of the housings 10 is achieved by the relief structuring 40 in this case, which can counteract, on the one hand, deformations as a result of an accident of the motor vehicle and also deformations as a result of expansions of the battery cells 12, i.e., as a result of so-called swelling, whereby a particularly robust battery module 14 can be implemented.

1. A battery module for a motor vehicle, comprising:
a plurality of prismatic battery cells, which are each enclosed by a housing, which has two housing walls arranged parallel to one another, which each provide a housing wall surface of the housing on the exterior, a plurality of housings being arranged in succession in the battery module in such a way that in each case at least two exterior housing wall surfaces abut one another, wherein in each housing, the housing wall surfaces each have a predetermined relief structuring, wherein the respective housing wall surfaces abutting one another have relief structurings designed corresponding to one another and are unconnected perpendicularly to the housing wall surface.

2. The battery module according to claim 1, wherein in each housing, in each case one of the two exterior housing wall surfaces forms a front side of the housing and the other forms a rear side of the housing, and both housing wall surfaces each comprise two equal-sized halves, wherein the respective relief structuring of the two halves of the front side and the two halves of the rear side is designed in such a way that both the front side is designed corresponding to the rear side and the two halves of a housing wall surface are designed corresponding to one another.

3. The battery module according to claim 1, wherein in each housing, between the two housing walls, a housing cover perpendicular to these housing walls is arranged, having two terminals for one electrical pole of the battery cell in each case.

4. The battery module according to claim 3, wherein in each housing, the housing cover has a U-shaped configuration and extends laterally in relation to the two housing walls up to a housing base arranged parallel to a middle part of the housing cover.

5. The battery module according to claim 4, wherein in each housing, the two housing walls, the housing cover, and the housing base are connected to one another in an integrally-joined manner.

6. The battery module according to claim 1, wherein in each housing, the two housing walls are each produced from a metal sheet, in particular having a wall thickness less than 1 mm.

7. The battery module according to claim 1, wherein each housing is sealed in a fluid-tight manner by means of a sealing material.

8. The battery module according to claim 1, wherein the successively arranged housings are held together by a clamping device with respect to a direction perpendicular to the housing wall surfaces.

9. The battery module according to claim 2, wherein in each housing, between the two housing walls, a housing cover perpendicular to these housing walls is arranged, having two terminals for one electrical pole of the battery cell in each case.

10. The battery module according to claim 2, wherein in each housing, the two housing walls are each produced from a metal sheet, in particular having a wall thickness less than 1 mm.

11. The battery module according to claim 3, wherein in each housing, the two housing walls are each produced from a metal sheet, in particular having a wall thickness less than 1 mm.

12. The battery module according to claim 4, wherein in each housing, the two housing walls are each produced from a metal sheet, in particular having a wall thickness less than 1 mm.

13. The battery module according to claim 5, wherein in each housing, the two housing walls are each produced from a metal sheet, in particular having a wall thickness less than 1 mm.

14. The battery module according to claim 2, wherein each housing is sealed in a fluid-tight manner by means of a sealing material.

15. The battery module according to claim 3, wherein each housing is sealed in a fluid-tight manner by means of a sealing material.

16. The battery module according to claim 4, wherein each housing is sealed in a fluid-tight manner by means of a sealing material.

17. The battery module according to claim 5, wherein each housing is sealed in a fluid-tight manner by means of a sealing material.

18. The battery module according to claim 6, wherein each housing is sealed in a fluid-tight manner by means of a sealing material.

19. The battery module according to claim 2, wherein the successively arranged housings are held together by a clamping device with respect to a direction perpendicular to the housing wall surfaces.
